(19) United States
(12) Patent Application Publication
(10) Pub. No.: US 2017/0114849 A1
(43) Pub. Date: Apr. 27, 2017

(54) GUIDING SYSTEM FOR A BRAKE PISTON OF A MOTOR VEHICLE DISK BRAKE

(71) Applicant: Continental Teves AG & Co. oHG, Frankfurt (DE)

(72) Inventors: Martin Gädke, Hofheim/Ts. (DE); Alexander Schuchard, Burgwald (DE); Frederic Zimnoch, Groß-Zimmern (DE); Reiner Müller, Hattersheim (DE); Holger Marschner, Oberursel (DE); Mathias Haag, Darmstadt (DE); Ulrich Ungethüm, Obertshausen (DE); Uwe Bach, Niedernhausen (DE); Wolfgang Ritter, Oberursel/Ts. (DE); Jochem Rausch, Essenheim (US)

(73) Assignee: Continental Teves AG & Co. oHG, Frankfurt (DE)

(21) Appl. No.: 15/400,963

(22) Filed: Jan. 7, 2017

Related U.S. Application Data
(63) Continuation of application No. PCT/EP2015/065448, filed on Jul. 7, 2015.

(30) Foreign Application Priority Data
Jul. 7, 2014 (DE) 10 2014 213 153.7

(51) Int. Cl. F16D 65/18; F16D 65/00

(52) U.S. Cl. CPC F16D 65/18; F16D 65/0006; F16D 2121/04

(57) ABSTRACT

A guiding system for a brake piston of a motor-vehicle disk brake comprises a brake piston, a cylindrical brake-piston bore for accommodating the brake piston in a housing in such a way that the brake piston can be axially displaced, and a ring seal supported in the housing in an axially immovable manner, which ring seal is elastically clamped between a cylindrical brake-piston wall and a recess in the brake-piston bore. In order to improve the NVH behavior in the avoidance of disturbing noises of motor-vehicle disk brakes, a reversibly elastically preloaded guiding means is clamped between the brake-piston bore and the brake-piston wall, which guiding means is supported on the housing and couples the brake piston to the brake-piston bore in such a way that the brake piston is oriented in a specific manner.

### CROSS REFERENCE TO RELATED APPLICATIONS

This U.S. patent application claims the benefit of PCT patent application No. PCT/EP2015/065448, filed Jul. 7, 2015, which claims the benefit of German patent applications No. 10 2014 213 153.7, filed Jul. 7, 2014, and 10 2014 219 334.6 filed Sep. 24, 2014 all of which are hereby incorporated by reference.

### TECHNICAL FIELD

The invention relates to a guiding system for a brake piston of a motor vehicle disk brake.

### BACKGROUND

In the known motor vehicle brakes, there is a systematic separation of functions in that forces are mechanically braced and the brake piston guided linearly in the housing by direct bearing contact on the basis of a defined finish-machined cylindrical fit of the paired component diameters, that it to say between the cylindrical brake piston wall and the cylindrical brake piston bore wall. An elastic sealing ring is accommodated in the housing on the plunger principle and seated centrally with radially inward resilience on the brake piston wall, in order to fulfil a hydraulic sealing function, and a so-called roll-back function following brake actuation. In the case of fixed-caliper brakes only a brake piston is pushed back by the roll-back function. In the case of floating-caliper brakes this return relates both to the brake piston and also to the housing.

Page 98 of the 3^{rd} edition (2006) of the Brake Manual-ISBN-10 3-8348-0064-3 schematically describes the basic working principle of a conventional floating-caliper brake and page 95 the mode of operation of a conventional sealing ring for use in motor vehicle disk brakes. Following release of an actuated brake, the brake piston is in the unpressurized state due to elastic recovery of the sealing ring, the wall thereof gripping adhesively on the brake piston wall, automatically drawn back (roll-back behavior). The recovering sealing ring consequently impresses said return effect on the brake piston and the housing.

DE 16 00 008 A1 discloses a method of influencing said automatic return behavior by reducing the coefficient of friction between the brake piston bore and the brake piston wall. To do this it is proposed to make the brake piston wall from carbon or graphite so that it is self-lubricating. This calls for exacting special processes, it is susceptible to wear and unfortunately the brake piston, in terms of its thermal and mechanical characteristics, does not function satisfactorily in all applications.

DE 38 00 679 A1 sets forth a sealing device, wherein one surface is roughened in order to reduce a stick-slip effect. Investigations have shown that by using a surface formed with such a microstructure (as opposed to an entirely smooth surface) it is possible to maintain a fine fluid wetting between the brake piston and the sealing ring, so that stick-slip is avoided. Since the sealing ring, due to fluid wetting and a low coefficient of friction, finds little adhesion or resistance for transmitting force to the brake piston, the roll-back behavior is also less pronounced. This may have a detrimental effect in the case of floating-caliper brakes.

DE 103 53 827 A1 provides for a sealing ring having at least one orbitally and annularly grooved sliding surface for bearing against a brake piston wall. Here the grooving runs transversely at right angles to a brake piston axis.

In order to improve the efficiency, DE 197 49 612 C2 discloses a fixed-caliper brake having a brake piston-cylinder unit and a wobble joint for the brake piston. For forming the wobble joint the brake piston accommodates an elastic seal. The brake piston is accommodated centrally in a piston bore and is flexibly and displaceably supported by the seal. Under pressure in operation of the brake, this allows a brake piston axis to be oriented at right angles to a rear side of a brake pad. Here the orientation inevitably varies as a function of an elastic housing deformation under an increasing brake pressure. The brake piston is clamped symmetrically in the radial direction by the seal (symmetrical clamping).

A more recent analysis designed to model the noise-vibration-harshness (NVH) in disk brakes largely focuses on preventing reduced comfort due to high-frequency noise. One finding of this research is that with current disk brake specifications and requirements subsequent detailed enhancements are generally no longer sufficient to achieve a lasting improvement. An object of the present invention, therefore, is to afford an overall improvement, that is to say a basic systematic improvement of the NVH and roll-back characteristics of the oscillating system in all operating states, that is also in an unpressurized state, without bringing hitherto beneficial effects into question.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The brake piston guide is considered as a sub-system of a motor vehicle brake system relevant to the modal acoustics that in a particular form can be “pitched and tuned”. Through a particular combination of the boundary conditions between the brake piston bore and the brake piston wall the guide means is clamped, reversibly elastically “tuned”, in such a way that the guide means is supported on the brake caliper housing, and permanently acts upon the brake piston with a defined action of lateral force, affording the brake piston wall a measured controlled, modal-acoustic coupling to the bore wall, as required. The guide means therefore produces a modally acoustic “eccentric” tuning inside the piston accommodation between the brake piston wall and the bore. The guide means/sealing ring accordingly for the first time has a dual function, in such a way that it performs and exercises not only the known sealing function but also at the same time a lateral force modulation function (in relation to the brake piston). A purely radially symmetrical seal clamping of a brake piston is refrained from by impressing a defined lateral force, asymmetrically modulated at the circumference, on the brake piston, which gives the piston a defined preferred orientation in a lateral direction and/or a defined setting angle. Accordingly, hysteresis errors in the brake piston return behavior, brake piston sticking, unwanted torsion of the brake piston, residual braking moments, discernible instability in brake pedal actuation and unwanted oscillation noises are prevented by the new type of accommodation due to the particular clamping and modal acoustic decoupling of the brake piston. The system is also standardized and simplified, because its guide function is performed substantially by standardized identical parts.

In one particular development it is possible to decouple a brake piston, as required, in all operating states through specific, asymmetrical elastic clamping. The piston is therefore given a specific orientation, axial offset and/or a defined setting angle α, wherein the brake piston axis may be arranged axially offset and/or inclined in relation to the piston bore even in the unpressurized state. Particularly with a specifically decentralized, that is to say asymmetrically and elastically laterally braced piston accommodation in the housing, it is possible by relatively simple means to impress varying preferred orientations on a piston in a lateral direction and/or if necessary to arrange the brake piston axis at an oblique angle in the housing. This in turn has the positive consequence that unwanted reductions in comfort can be prevented by means of acoustic tuning. All of this is done very cost-effectively in the case of piston bores conventionally machined at right angles in the housing, and moreover in the actuated as well as the unactuated operating state. Since quite differently acting and primarily mechanically manifest alternative solutions for the lateral force modulation have been identified the characteristics for each of these may be designated singly or associated with one another in any combination, without departing from the scope of the invention.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 schematically illustrates a floating-caliper brake;

FIG. 2 shows an enlarged view of a portion of a brake piston bore including accommodation for a guide means in a housing;

FIGS. 3 to 5 show different views of a first embodiment of a guide means;

FIGS. 6 and 7 show different views of a second embodiment of a guide means;

FIG. 8 shows a detail of the guide means according to FIGS. 6 and 7 in an installed situation in a housing;,

FIGS. 9 and 10 show different views of a third embodiment of a guide means;

FIG. 11 illustrates details of the guide means according to FIGS. 9 and 10 in an installed situation in a brake piston bore of a housing;

FIG. 12 shows a qualitative comparison of the action of forces F of the piston clamping in relation to the piston displacement s, using the different configurations, that is according to a) conventional, rigid piston guide system, b) additionally decoupled, centrally pre-stressing guide element, c) eccentrically pre-stressing, eccentric guide element, and d) axially offset groove between guide element and/or seal;

FIG. 13 shows an embodiment of the invention having an axially offset groove and a special groove profile; and

FIG. 14 shows a dual piston application of the embodiment according to FIG. 13.

### DETAILED DESCRIPTION

Each hydraulic actuator such as, in particular, a motor vehicle disk brake 1 comprises at least one guiding system 2 for at least one translationally displaceable brake piston 3, which is accommodated in a housing 4, such as, in particular, in a brake caliper or cylinder. Here the guiding system 2 may relate equally both to the guiding systems of the brake pistons of input actuators (that is hydraulic brake master cylinders, for example) or to the guiding systems for brake pistons of output actuators (such as motor vehicle hydraulic disk brakes, for example).

Brake master cylinders generally comprise two brake pistons (primary and secondary piston), hydraulically connected independently of one another and accommodated so that they are translationally displaceable in a bore, which pistons as a displaceable wall define pressure chambers, which are connected to pressure chambers of associated motor vehicle disk brakes, which are in turn defined by brake pistons. In a motor vehicle disk brake 1 of the floating-caliper type at least one brake piston 3 defines a pressure chamber 5, which is actuated by a hydraulic upstream input actuator. Motor vehicle disk brakes 1 of the fixed-caliper type, however, comprise at least one brake piston 3 on each side of a brake disk 6.

When actuated by a master cylinder, incompressible brake fluid in each volumetrically closed hydraulic system (master cylinder, pipelines, brake hose lines, motor vehicle disk brake 1, brake piston 3) is subjected to hydraulic pressure in accordance with the law of volume constancy, in such a way that at least one friction lining 7, 8 is directly or indirectly pressed against a rotor (brake disk 6) by the brake piston 3 after overcoming a so-called free travel. A surface unit pressure (cf. brake pressure), which correlates with a specific brake application force, serves as a measure of this braking action. For releasing the motor vehicle disk brake 1 the master cylinder is released, unactuated. The sealing ring 9 is accommodated in a recess/groove 10. The elasticity and elastic roll-back effect of the sealing ring 9 is exploited for returning the brake piston 3. Consequently, the desired clearance after braking is produced substantially by a reversible return deformation of the sealing ring 9.

A brake piston 3 is basically of cup-shaped construction and comprises a brake piston head 11 and a cylindrical brake piston wall 12. According to the type of disk brake, either the brake piston head 11 or an exposed edge of the brake piston wall 12 may act directly on the friction lining 7, 8.

The guiding system 2 for a brake piston 3 of a motor vehicle disk brake 1, or other actuators, comprises a brake piston bore 13 arranged concentrically with and cylindrically around the brake piston 3 for the axially displaceable accommodation of the brake piston 3 in the housing 4 (in particular a brake caliper housing), and a sealing ring 9 which is supported in the brake caliper housing and is elastically clamped between the cylindrical brake piston wall 12 and the recess 10 of the brake piston bore 13, and which serves the functions described above.

A guide means 15 is provided in a reversibly elastically clamped manner in a gap 14 between the brake piston bore 13 and the brake piston wall 12, which guide means is supported on the brake caliper housing and permanently clamps the brake piston 3 with a defined action of forces in a radial direction in such a way that the brake piston wall 12 is coupled, with a specific orientation, to the brake piston bore wall. This accordingly results in an oriented accommodation of the brake piston 3 in the housing 4. A guide means 15 clamping with a defined elastic pliability affords an improved introduction of lateral forces into the housing 4.

The guide means 15 is to be integrally formed with the sealing ring 9 and arranged in a common recess of the brake piston bore 13, so as to reduce the assembly and machining outlay. If the machining and assembly outlay are of lesser concern, and a facility for separate replacement is desired, the guide means 15 and the sealing ring 9 may be formed and accommodated side-by-side as separate components. For this purpose, the guide means 15 and the sealing ring 9 are located at an axial interval from one another, each in separate recesses 10, 16 of the brake piston bore 13. The recesses 10, 16 may comprise fixing means such as, in particular, parallel bearing faces 17, 18 for the sealing ring 9 and the guide means 15. In principle, there is scope for providing the guide means 15 with a uniform clamping force over the circumference of the brake piston. In service this automatically results in the provision of a brake piston axis A substantially at right angles to the friction surfaces of the brake disk 6.

In an alternative configuration, wherein a sealed gap 14 runs between the brake piston bore 13 and the brake piston wall 12, and the brake piston axis A is not set at right angles to the friction surface of the brake disk 6 but at a defined oblique angle. This is achieved in one embodiment in that a radial action of force of a clamping of the brake piston wall 12 is not provided uniformly over the brake piston circumference, and the lateral forces do not cancel one another out. What is more, as a result a defined lateral force with a corresponding resultant preferred orientation is impressed on the brake piston 3, wherein the setting angle obtained corresponds to the direction of the resultant lateral force. The action of the forces, in this way non-uniformly distributed over the brake piston circumference, for producing a setting angle can be obtained through corresponding adaptation of the elasticity of a material of the guide means 15.

Accordingly, according to FIGS. 3-5 a cross section of the guide means 15 is specifically designed to be pliably elastic in a preferred displacement area, for example through raised ribs 19 protruding convexly outwards, lobes or similar projections and at least one correspondingly associated integral cavity 20. The cavity 20 affords the necessary elastic freedom of movement. Moreover, a radial lateral force is impressed on the brake piston 3, where necessary lending it a predefined, desired setting angle α. The individual ribs 19 or lobes preferably extend more lengthwise than widthwise and running uniformly in an axial direction, that is to say oriented parallel to the brake piston axis A. The height of the ribs 19 in this context defines the radial clamping of the brake piston 3 in accordance with the outside diameter of the brake piston wall 12 and the inside diameter of the brake piston bore 13.

In a simple variant according to FIGS. 6-8 a separate guide means 15 may be formed as a simple corrugated ring from a solid material (for example spring steel) of uniform wall thickness, the cross section of which is meander-shaped and has alternating convex and concave portions. A correspondingly adapted coaxial-cylindrical brake piston wall and a coaxial-cylindrical brake piston bore 13 are assigned to this. Alternatively or in addition to this another variant suggests itself, in which the guide means is formed as a bow spring having at least one sprung arm.

As a further alternative or addition, it is feasible to provide the respective groove seats for the sealing ring and/or guide means axially offset in the housing—that is to say with an axial offset Δ in relation to the piston bore. As a further alternative or addition, it is feasible to form the sealing ring and/or the guide means eccentrically. As a further alternative or addition, it is possible to provide the sealing ring 9 and/or the guide means 15 formed from a material of different elasticity. It is possible for the elastic guide means 15 to comprise at least one component formed at least partially from a metal material, such as, in particular, spring steel. It is in particular possible to provide different, alternating moduli of elasticity in relation to the azimuth angle (Az). This is possible, for example, by virtue of the aforementioned material composite structure and/or another elastomer multi-material construction.

Alternatively or in addition, the orbital elastic pressure modulation at the circumference, in particular directed radially at the brake piston 3, may be obtained in that a recess 10, 16 for accommodating the sealing ring 9 and/or guide means 15 is provided with a profiled base surface 40 by providing at least one or more irregularities on the circumference of the base surface 40. The irregularity may be formed as a sectoral flattening, protuberance, recess or other deformation of the base surface 40, allowing a correspondingly modified accommodation and action of the sealing ring 9 and/or guide means 15 to achieve correspondingly modified, modulated spring effects, which orbitally at the circumference produce the desired pressure modulation, basically directed radially at the piston 3. Accordingly, the irregularity/irregularities is/are preferably provided radially oriented in the base surface 40 and may preferably be designed as variations in radius, so that the base surface runs as a closed, non-circular, elliptical, ovoidal or other freeform curve around the brake piston 3. Said pressure modulation therefore makes it possible to achieve the spot and/or linear contact at the * point between brake piston wall 12 and brake piston bore wall represented in principle and by way of example in FIG. 12 A-D—where necessary maintaining the setting angle α described (angle between the brake piston axis A and the bore axis in the housing 4).

The annular guide means 15 according to the invention is furthermore preferably formed entirely or at least partially from a plastic material, such as in particular PTFE or a PTFE constituent. The guide means is more preferably of annular design, wherein at least one ventilation duct 21—as it were, as a bypass—is provided for the purpose of pressure equalization and for the return flow of fluid (brake fluid) into the pressure chamber 5. Each ventilation duct 21 may be designed as an aperture 22 provided radially or obliquely on the annular guide means 15. It is possible for the guide means 15 to have additional ducts (particularly ducts opening radially inwards and radially outwards) for improved elastic deformation and for pressure equalization in its wall. It is possible to form the guide means 15 as a composite body composed of multiple plastic materials in layers and/or having rigid substrate parts, in order to utilize different material characteristics for optimizing the component characteristics.

In a particular variant of a guide means according to FIGS. 9-11 it is formed as a sprung clip 23 having multiple arms 24, 25, 26, 27 including free ends radiating from a center Z, and wherein the arms 24-27 are accommodated for locating purposes in fixing depressions 32-35 of the brake caliper housing, and wherein the free ends 28-31 of the clip 23 each comprise one or more arms 36, 37 for resting on the circumference of the brake piston 3. Here the arms 36, 37 are preferably seated at regular intervals on the circumference intermittently elastically sprung radially inwards on the wall of the brake piston 3, thereby clamping the brake piston 3.

FIG. 13 illustrates an embodiment having a sealing ring 9, wherein corresponding features are identified by corresponding reference numerals. Figure here describes, by way of example, a dual piston application, wherein Kₙ in each case symbolizes the respective piston. All embodiments provide for a solution through a combination of multiple features. In each pairing the reference numeral 14 denotes a radially measured, maximum play between the brake piston wall 12 and the brake piston bore 13 in the housing 4. Moreover, the groove 10 is located axially offset in the housing 4 by the express offset Δ in the radial direction R to the bore axis B. Furthermore, the groove 10 has multiple peripheral irregularities (flattenings) U₁-Uₙ on its fundamentally annular base surface 40, staggered by an angle α of approximately ≈60° at the circumference. In conjunction with the clamped sealing ring 9 and the brake piston wall 12, the irregularities U generate an associated, radially directed force F₁-F_{N}. The addition of forces culminates in a resultant force component F_{R} directed radially in the 9 o'clock position, which is also partially illustrated in FIG. 12. For additional boosting of this modal-acoustic tuning inside the brake piston guide, it is advisable to add further features to the combination, or to interchange these in order to lend the brake piston 3 a radially directed preferred orientation in the direction of the bore wall in specific modal tuning. Consequently, in accordance with the resultant force component FR on one side, the brake piston wall 12 has an especially effective modal-acoustic coupling to the bore wall of the housing 4. It goes without saying here that the unilaterally boosted coupling between the brake piston wall 12 and the brake piston bore 13 produces an enhanced relief or decoupling on the opposite side.

With regard to the versions shown according to FIGS. 13 and 14, a correspondingly uniform angular orientation of the irregularity U1, U2 at P1 and P2 is presented for each piston 3, so that a uniformly directed resultant force also ensues. Resorting to positional data on the model of a notional, analog clock face, U1 here in each case coincides with location P1 roughly in a 2 o'clock position, and U2 is situated at location P2, in each case roughly in a 4 o'clock position, always in relation to the center of the respective brake piston 3. This angular orientation may be modified in fine tuning of the modal-acoustic behavior of a vehicle. Thus, it is feasible, advisable and possible for certain modified applications, for example, to specifically modify the positioning P in direction P3, P4 in order to modify the direction of the resultant force FR. Thus in the case of dual-piston applications, for example, a piston 3 arranged on the left, for example, may be acted upon from the direction of position P3 corresponding to the 8 o'clock position and from the direction P4 corresponding to the 10 o'clock position. This has the advantageous effect that the resultant forces F_{RK1} and F_{RK2} cancel one another out. These possible variations and locations are naturally further enhanced for 3-piston arrangements, without however bringing the core idea of the invention into question.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A guiding system for a brake piston of a motor vehicle disk brake comprising:
a brake piston;
a housing defining a brake piston bore for accommodating the brake piston, wherein the brake piston is axially displaceable relative thereto;
a guide device, which is elastically clamped between a cylindrical brake piston wall and a groove in the brake piston bore;
a sealing ring; and
wherein the brake piston is reversibly elastically clamped in the brake piston bore by the guide device, impelled in a radial direction by a defined action of lateral forces, in order to afford the brake piston wall a directed modal-acoustic coupling to the brake piston bore.

2. The guiding system of claim 1, wherein the guide device and the sealing ring are arranged in the groove of the brake piston bore.

3. The guiding system of claim 2, wherein the guide device comprises at least one component formed at least partially from a plastic material.

4. The guiding system of claim 1, wherein the guide device and the sealing ring are formed as separate components from another.

5. The guiding system of claim 1, wherein the guide device and the sealing ring are arranged at an axial interval from one another in separate recesses in the brake piston bore.

6. The guiding system of claim 5, wherein the recesses comprise fixing elements.

7. The guiding system of claim 6, wherein the fixing elements are bearing faces for the sealing ring and the guide device.

8. The guiding system of claim 1, wherein the forces applied to the brake piston by the guide device in a radial direction is distributed symmetrically and equally over a brake piston circumference.

9. The guiding system of claim 1, wherein the forces applied to the brake piston by the guide device in a radial direction is distributed asymmetrically and unequally over a brake piston circumference, in such a way that a resultant lateral force impresses one of a preferred orientation and a predefined setting angle on the brake piston in relation to the brake piston bore.

10. The guiding system of claim 1, wherein the guide device comprises one of multiple convex projections such as ribs and multiple recesses distributed over its circumference.

11. The guiding system of claim 1, wherein the guide device is provided with at least one of: at least ventilation duct and at least one aperture for the equalization of pressure and for returning fluid into a pressure chamber.

12. The guiding system of claim 1, wherein the guide device comprises at least one arm, which is resiliently clamped between the housing and the brake piston.

13. The guiding system of claim 12, wherein the guide device is formed as an elastic clip having multiple arms radiating radially from a center with free ends, wherein the arms are accommodated in fixing depressions of the housing, and wherein the free ends each additionally comprise at least one spring element.

14. The guiding system of claim 1, wherein at least one of the guide device and the sealing ring is formed eccentrically.

15. The guiding system of claim 1, wherein the groove for accommodating the at least one of the guide device and the sealing ring is arranged offset with an axial offset in a radial direction relative to the bore axis.

15. The guiding system of claim 1, wherein one of the guide device and the sealing ring is formed from elastomer material having at least two moduli of elasticity designed for differing pliability, and wherein the different moduli of elasticity are provided alternately on the circumference.

16. The guiding system of claim 1, wherein one of the groove and the recess is provided with a profiled bearing surface, which comprises at least one base surface having an irregularity.

17. The guiding system of claim 16, wherein the irregularity is formed as one of: a sectoral flattening, a protuberance, a recess, and another deformation of the base surface in order to obtain a radially directed pressure modulation on the piston orbitally at the circumference though correspondingly interlocking action on one of the sealing ring and the guide device.

18. The guiding system of claim 17, wherein the irregularity is provided as a radially directed variation in the radius of the recess.

19. The guiding system of claim 16, wherein the groove comprises multiple irregularities staggered by an angle at the circumference.

20. The guiding system of claim 1, wherein the location of the irregularity produces a resultant lateral force at the circumference of the brake piston.
